(19) United States
(12) Patent Application Publication
(10) Pub. No.: US 2003/0153423 A1
(43) Pub. Date: Aug. 14, 2003

(54) Bicycle chainring fastener system

(76) Inventor: Garrett Andrew Smith, San Luis Obispo, CA (US)

Correspondence Address: Garrett A. Smith, 1365 Bishop Street, San Luis Obispo, CA, 93401, US

(21) Appl. No.: 10/077,665

(22) Filed: Feb. 14, 2002

(51) Int. Cl. F16H 55/12; F16H 55/30

(52) U.S. Cl. 474/160

(57) ABSTRACT

A fastener system for attaching bicycle chainrings to a bicycle crank comprised of a nut and a bolt. Both the nut and bolt consist of shafts with flanges on one end. The nut has threads formed on the interior of its shaft, while the bolt has threads formed on the exterior of its shaft. The nut and bolt can thus be threadedly engaged with each other to clamp the chainrings to the crank. Both the nut and bolt contain tool engagement interfaces formed on the interior of their respective shafts.

### TECHNICAL FIELD

The present invention pertains to nut and bolt fastener assemblies for use on bicycle crank assemblies.

### BACKGROUND OF THE INVENTION

Typical human powered bicycles are propelled by pedals mounted on cranks at opposite ends of an axle. The cranks drive one or more sprockets, or chainrings, which in turn engage a chain to transfer the rotary motion of the cranks to a rear wheel. In typical crank assemblies one or more chainrings are mounted to one of the crank arms by fasteners. These fasteners attach the chainrings to the support arms radiating from a central hub of the crank. The hub of the crank in turn rotates on an axle rotatably mounted in the bicycle frame.

A common way of securing the chainrings to the crank involves corresponding holes in each piece, with the fastener system passing through the holes and securing the pieces together. There are currently two types of fastener systems employed for this purpose: rivets or nuts and corresponding bolts. It is desirable for the design of this fastener system to occupy as little volume as possible to allow for other piece(s) of the assembly to fit in the same area, to provide clearance to a moving chain, and simply for aesthetic reasons.

For rapid and easy assembly and reduction of cost rivets are most commonly used as a fastening system on inexpensive bicycle cranks. Due to their low profile, rivets satisfy the desire to minimize the fastener volume. An inconvenience of this arrangement is that by nature, rivets are a permanent fixing device, requiring destruction of the rivet if the unit must be disassembled.

To allow for servicing of individual chainrings a nut and bolt fastener system is typically used on more expensive bicycle cranks. A nut and bolt system for attaching chainrings to the crank has existed for decades with the characteristics shown in FIG. 1. In this system the bolt is comprised of an externally threaded shaft, a flange on one end, and a tool interface. The tool interface is most commonly a hex profile cut into the center of the flange and shaft section, although other types of common tool interfaces are occasionally used. The nut is comprised of a shaft with an internal thread passing through its entire length, an exterior flange, and a tool interface cut into the flange. This tool interface comprises of a slot requiring a special tool to hold the nut during assembly or removal. Since it is desirable to minimize the volume of the fastener system the flanges of the nut and bolt are kept relatively thin, which results in a minimum tool engagement depth for the nut.

The nut and bolt of the current state-of-the-art are assembled such that the external thread on the bolt is inserted into, and corresponds with, the internal thread on the nut. The nut is threaded completely through to allow the threaded end of the bolt to protrude to the outside of the flange on the nut. The nut and bolt secures the chainring(s) to the crank support arms by using the exterior cylindrical surface of the nut's shaft as a locating device, and by exerting a clamping force on the objects being assembled through the pressure exerted by the flanges of both the nut and bolt resulting from tightening the nut and bolt together. Examples of such nut and bolt fastener systems as just described are shown in patents relating to cranks and chainrings such as U.S. Pat. No. 5,480,359 and E.P. 0 002 903.

### SUMMARY OF THE INVENTION

One object of the present invention is to provide a fastener system for mounting bicycle chainrings to bicycle cranks that provides for a combination of high fastener and tool engagement strength. The inventor has recognized that the maximum pressure exerted to secure a chainring to a crank arm is a function of the ability to convert tightening torque into fastener tension. High fastener tension is desirable not only because it securely fastens the chainring(s) to the crank support arms but also because it prevents the nut and bolt system from loosening during use of the crank assembly. The transfer of tightening torque into fastener tension is governed by the strength of the fastener and the strength of the tool interface. It is therefore desirable to provide a fastener assembly with high fastener and high tool interface strength.

Another object of the present invention is to provide a fastener system that is simple and fast to assemble or disassemble. The inventor has recognized the need for improved tool engagement interfaces on the nut and bolt fastener system such that automated assembly tools and fixtures can easily hold either the nut or bolt from either the inside or outside of the crank assembly. In this manner, assembly of the chainring(s) onto the crank can be accomplished in a simple, flexible, efficient manner.

According to the above objects, the present invention provides for an improved fastener system for attaching one or more chainrings to a bicycle crank arm consisting of a nut and bolt with the following features:

The bolt of the present invention consists of an externally threaded shaft with a flange on one end. A tool engagement interface is provided on the interior of the shaft, such that a tool can be used to rotatably hold or tighten the bolt. The external thread diameter and tool interface size and depth are structurally optimized to provide for a compact bolt that can still fit the existing interface holes in typical bicycle cranks and chainrings. A substantial strength increase over existing chainring bolt designs is therefore achieved. Thus, the clamping force generated by the fastener assembly is greatly increased and the propensity of the fastener system to loosen during use is diminished or eliminated.

The nut of the present invention consists of an internally stepped cylinder with a flange on one end. A tool engagement interface is provided on the smaller internal diameter of the cylinder, adjacent to the flanged end, such that a common tool can be used to rotatably hold or tighten the nut. Threads are formed on the larger internal diameter part of the cylinder and mate with the corresponding exterior threads of the bolt. The size of the internal threads of the nut, and thus the bolt, are structurally optimized to provide for a compact fastener system with exceptional strength that still fits existing interface holes in typical cranks and chainrings. Additionally, the size of the tool engagement interface is structurally optimized relative to its depth and the outside diameter of the cylinder to provide for the greatest possible tool engagement and nut strength.

Since both the nut and bolt of the invention include tool interface portions that are internal to their diameters and structurally optimized to provide for high tool engagement strength, either the nut or the bolt can be effectively used on either the outside or inside of a crank and chainring assembly. Thus, assembly of the chainrings on the crank can be performed in the most efficient manner to meet the requirements of the assembler. Further, the use of high strength internal tool engagement interfaces makes automation of the assembly process, especially the fixtures or machines that rotatably tighten the fasteners, much easier to implement and maintain than the traditional nut and bolt system.

Other benefits and advantages of the present invention will become apparent from the following detailed description of a preferred embodiment of the invention with reference to the drawings.

### BRIEF DESCRIPTION OF DRAWINGS

FIG. 1 is an enlarged, exploded, fragmentary perspective view of the common prior-art nut and bolt fastener system used to attach the two largest chainrings to a bicycle crank support arm.

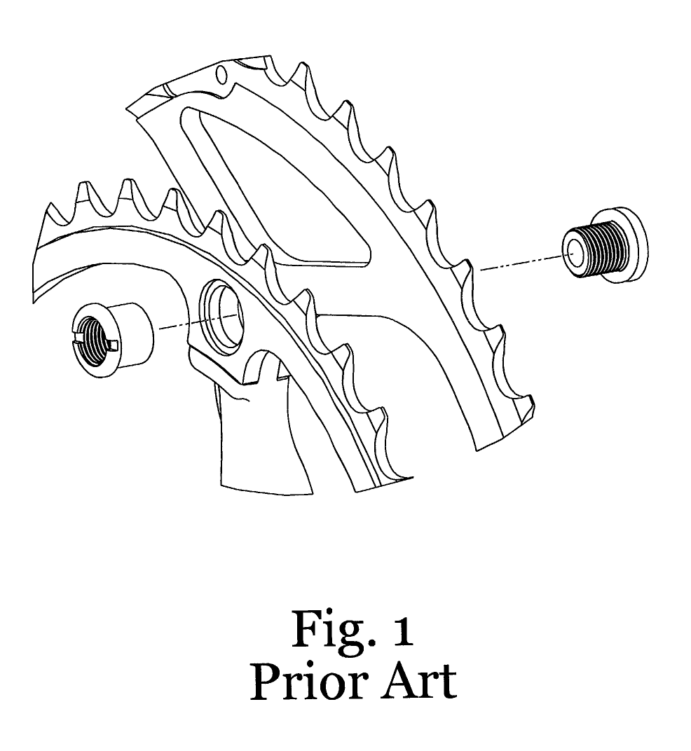

FIG. 2 shows a side view of a bicycle.

FIG. 3 is an enlarged perspective view of the crank and chainrings from the bicycle of FIG. 1.

FIG. 4 is an enlarged, exploded, fragmentary perspective view of the nut and bolt fastener system used to attach the two largest chainrings to the bicycle crank support arm from FIG. 3.

FIG. 5 is an enlarged, fragmentary, radial cross-sectional view of the assembled nut and bolt fastener system, chainrings, and crank from FIG. 4.

FIG. 6 is a perspective view of the bolt from the fastener system of FIG. 4.

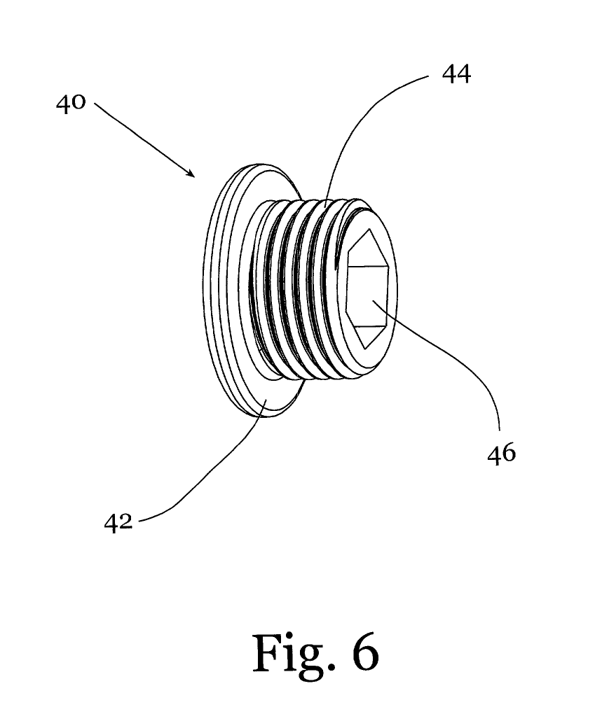

FIG. 7 is a perspective view of the nut from the fastener system of FIG. 4.

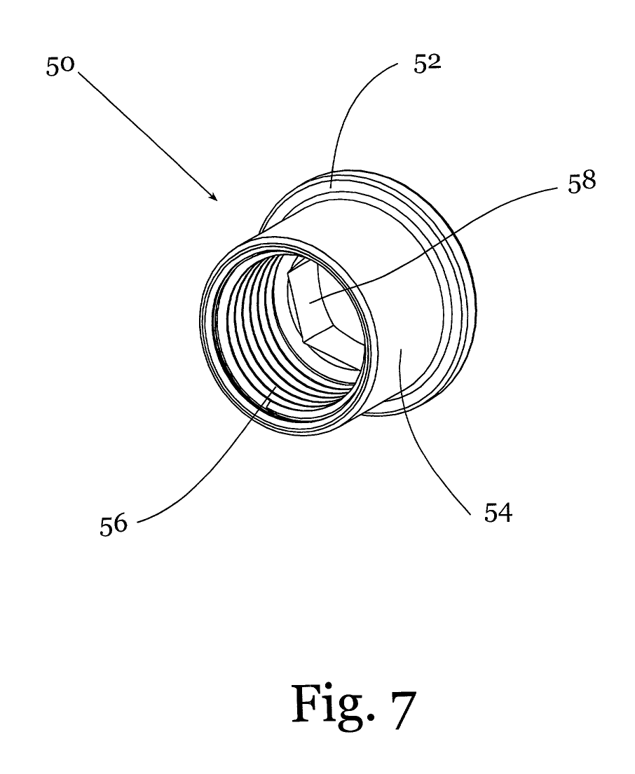

### DETAILED DESCRIPTION OF THE PREFERRED EMBODIMENT

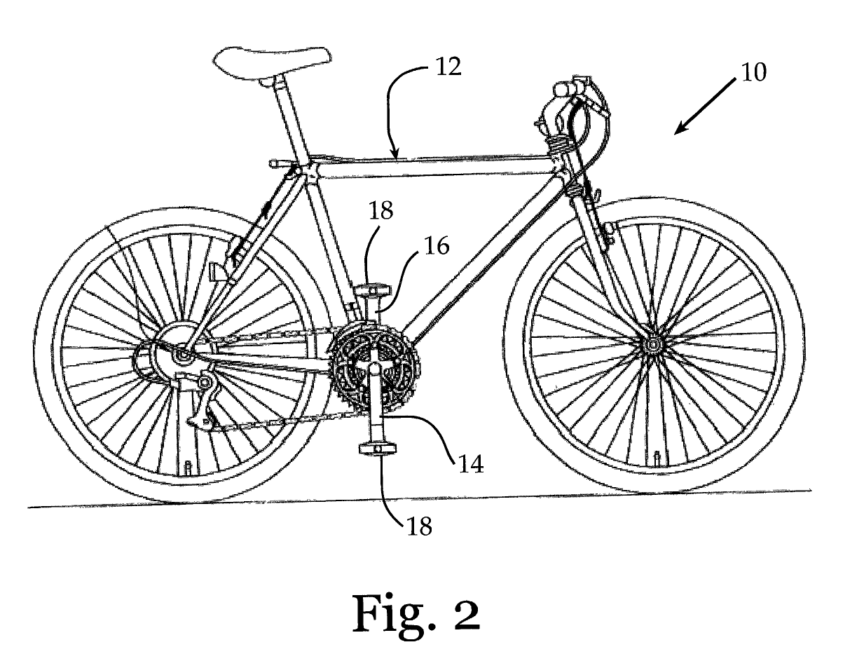

FIG. 2 generally shows a bicycle 10 with a bicycle frame 12, on which are mounted cranks 14, 16 with pedals 18. Crank 14 is an assembly comprising of the crank arm with fastener systems attaching a plurality of chainrings to the crank arm.

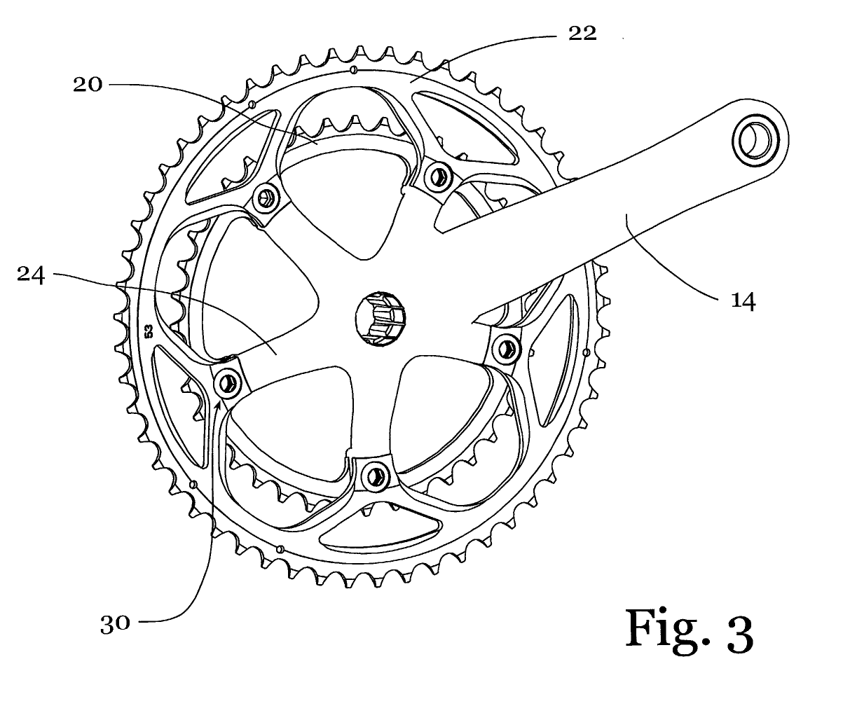

FIG. 3 shows an enlarged perspective view of the crank 14. Chainrings 20, 22 are rotatably secured to the support arms 24 of crank 14 by fastener systems 30.

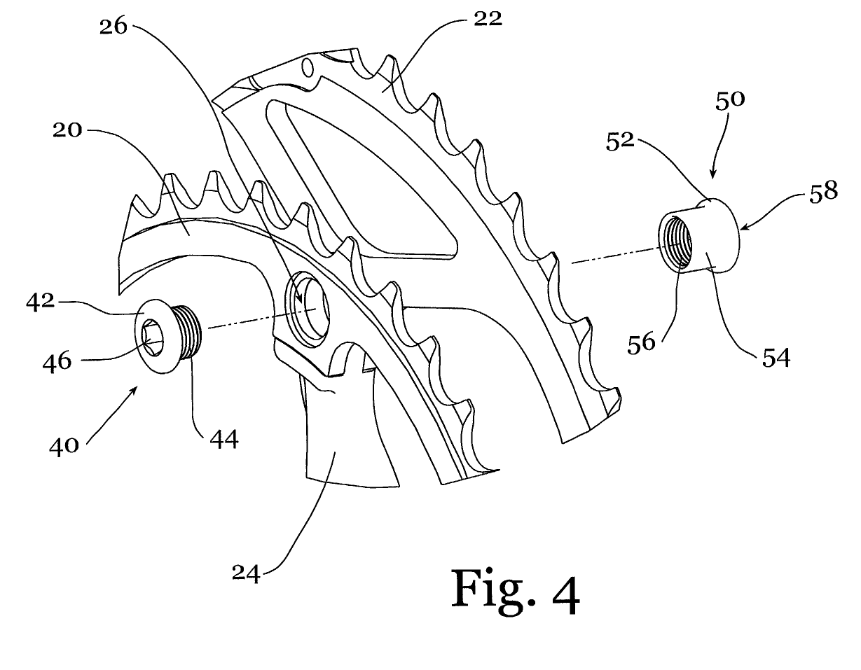

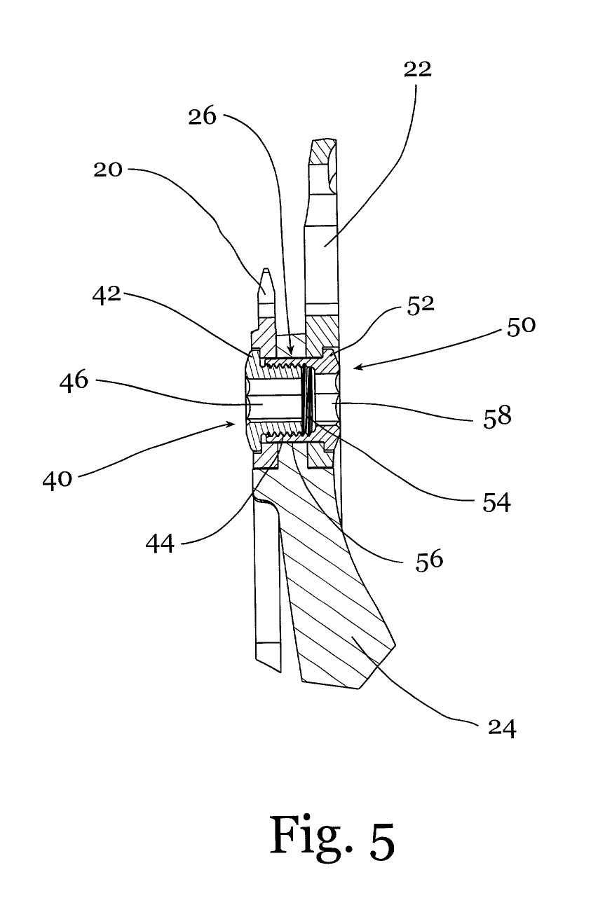

FIG. 4 shows the preferred embodiment of the fastener system 30, which comprises of a bolt 40 having an exterior flange 42, an exterior thread 44, and a tool locating area 46; and a nut 50 having an exterior flange 52, an exterior cylindrical mating surface 54, an internal threaded bore 56, and an internal tool locating area 58 that is not visible in this view. The bolt 40 and nut 50 assemble to each other such that threads 44 and 56 correspond to each other and assemble as a standard nut and bolt combination. This assembly of the bolt 40 and nut 50 fasten together an inner chainring 20 and an outer chainring 22, with a crank support arm 24 clamped therebetween. In this instance flange 42 of the bolt 40 is mated to the inner chainring 20 while the flange 52 of the nut 50 is mated to the outer chainring 22. The external cylindrical mating surface 54 of the nut 50 is closely matching in size to the fixing holes generally indicated as 26 provided in the chainrings 20, 22 and the crank support arm 24. In this manner the inner and out chainrings 20, 22 are co-located with the crank support arm 24 through the mating cylindrical surfaces 54 and 26. The entire assembly is held fast by rotating the bolt 40 or nut 50 in the direction of engagement for the mating threaded portions 44 and 56. The bolt 40 or nut 50 are rotated relative to each other by engaging corresponding tools into the tool interfaces 46, 58 and rotating one tool relative to other. As these pieces rotate relative to each other in the direction of engagement for the mating threaded portions 44 and 56, flanges 42 and 52 come into contact with and exert pressure on the inner and outer chainrings 20, 22. This condition is shown in FIG. 5.

It is important to generate sufficient tension in the fastener assembly 30, and thus clamping pressure in the assembled members 20, 22, and 24, to fixedly hold the entire assembly together and prevent the fastener assembly 30 from loosening during use. This is accomplished by structurally optimizing the sizes of threaded portions 44 and 56 and the tool engagement interfaces 46 and 58. In the preferred embodiment the outside diameter of the exterior thread 44 is 8.5mm with a thread pitch of 0.75 mm. The interior threaded portion 56 of nut 50 is correspondingly sized. The tool engagement interface 46 in bolt 40 is a hexagonal shape with a distance across the flat surfaces of the hexagon of 5 mm and extends entirely through the center of bolt 40. Other tool interface shapes may also be used, such as crosses, splines, or other multi-lobed interfaces shapes. This combination of thread size, pitch, and tool engagement interface 46 results in an approximately homogeneous strain distribution throughout the general cross-section of the bolt 40 and nut 50. In this way the strain energy stored in the fastener system 30 resulting from tightening the bolt 40 and nut 50 together is maximized to prevent loosening of the assembly during use.

The structural optimization of the fastener system as just discussed, combined with the improved strength of the internal tool interfaces 46, 58, allows the bolt 40 and nut 50 to be made from lightweight materials that previous fastener systems have been unable to employ. For example aluminum, plastic, or composite materials may be effectively used to decrease the overall weight of the crank assembly, thereby providing the bicycle rider with an improved power to weight ratio.

In FIG. 5 it can be seen that the tool interface 58 in the nut 50 is not as deep as the tool interface 46 in bolt 40. This is a result of maximizing the number of threads 44 in engagement with corresponding threads 56. The tool interface 58 in nut 50 is a hexagonal shape similar to that in the bolt 40, but with the distance across the flat surfaces of the hexagon being equal to 6mm. In this manner, even though the tool engagement depth for the nut 50 is not as deep as that for the bolt 40, the larger tool size results in a torque capacity for the nut 50 equal to that for the bolt 40. Thus, either the bolt 40 or nut 50 may be rotated relative to the other to achieve the proper fastener tension in the assembly.

Further, since both tool interfaces 46, 58 are interior to the bolt 40 and nut 50, the bolt 40 and nut 50 look similar to each other. Thus, either the bolt 40 or nut 50 can be used on the exterior of the crank without worry of the aesthetic controversies surrounding the choice. In this way the fastener system 30 is adaptable to many different assembly methods. Further, due to the relatively deep internal tool interfaces 46 and 58, it is much easier to design automated assembly fixtures and tools to mate to and fixedly hold either the bolt 40 or nut 50. Again, this makes the fastener system 30 very adaptable to various assembly methods and procedures.

Although the invention has been explained in relation to its preferred embodiment, it is to be understood that many other possible modifications and variations can be made without departing from the spirit and scope of the invention as hereafter claimed.

1. A fastener system for attaching a chainring to a bicycle crank, comprising:
a nut comprising of an internally threaded cylinder, an external flange on one end of said cylinder, and a tool interface means formed inside said cylinder;
a bolt that threadedly engages said nut, comprising of an externally threaded shaft, a flange on one end of said shaft, and a tool interface means formed inside said shaft;
whereby said bolt and said nut tighten together to clamp a chainring to a bicycle crank support arm.

2. The fastener system according to claim 1, wherein said tool interface means of said nut and said bolt are of equal shape such that the same tool can be used with either said nut or said bolt.

3. The fastener system according to claim 1, wherein said tool interface means of said nut and said bolt are of different sizes such that the torque capacity of said tool interface means is maximized.

4. A fastener system for attaching a plurality of chainrings to a bicycle crank, comprising:
a nut comprising of an internally threaded cylinder, an external flange on one end of said cylinder, and a tool interface means formed inside said cylinder;
a bolt that threadedly engages said nut, comprising of an externally threaded shaft, a flange on one end of said shaft, and a tool interface means formed inside said shaft;
whereby said bolt and said nut tighten together to clamp a plurality of chainrings to a bicycle crank support arm.

5. The fastener system according to claim 2, wherein said tool interface means of said nut and said bolt are of equal shape such that the same tool can be used with either said nut or said bolt.

6. The fastener system according to claim 2, wherein said tool interface means of said nut and said bolt are of different sizes such that the torque capacity of said tool interface means is maximized.

7. A bicycle crank assembly comprising:
a crank arm;
chainring support means attached to said crank arm;
one or more chainrings attached to said chainring support means by a nut and bolt system;
said nut comprising of an internally threaded cylinder, a external flange on one end of said cylinder, and a tool interface means formed inside said cylinder;
said bolt comprising of an externally threaded shaft that threadedly engages with said nut, a flange on one end of said shaft, and a tool interface means formed inside said shaft;
whereby said nut and said bolt tighten together and fixedly clamp said chainrings to said chainring support means.

8. The bicycle crank assembly according to claim 7, wherein said tool interface means of said nut and said bolt are of equal shape such that the same tool can be used with either said nut or said bolt.

9. The bicycle crank assembly according to claim 7, wherein said tool interface means of said nut and said bolt are of different sizes such that the torque capacity of said tool interface means is maximized.

10. The bicycle crank assembly according to claim 7, wherein said tool interface means of said bolt faces to the outside of said crank assembly.

11. The bicycle crank assembly according to claim 7, wherein said tool interface means of said nut faces to the outside of said crank assembly.

12. A bicycle with a crank assembly comprising:
a crank arm;
chainring support means attached to said crank arm;
one or more chainrings attached to said chainring support means by a nut and bolt system;
said nut comprising of an internally threaded cylinder, a external flange on one end of said cylinder, and a tool interface means formed inside said cylinder;
said bolt comprising of an externally threaded shaft that threadedly engages with said nut, a flange on one end of said shaft, and a tool interface means formed inside said shaft;
whereby said nut and said bolt tighten together and fixedly clamp said chainrings to said chainring support means.
